(19) United States
(12) Patent Application Publication
(10) Pub. No.: US 2008/0229962 A1
(43) Pub. Date: Sep. 25, 2008

(54) Sublimation transfer paper, method of making, and method for sublimation printing

(76) Inventors: Matthew Warren Shedd, Chelsea, ME (US); Bryan David Jose, Readfield, ME (US); Robert James Preece, Skowhegan, ME (US); Gregory John Bizier, Livermore, ME (US)

Correspondence Address: MERCHANT & GOULD PC, P.O. BOX 2903, MINNEAPOLIS, MN, 55402-0903, US

(21) Appl. No.: 11/725,572

(22) Filed: Mar. 19, 2007

(51) Int. Cl. B41F 23/04; G03G 7/00

(52) U.S. Cl. 101/487; 428/211.1

(57) ABSTRACT

Sublimation transfer paper is provided according to the present invention. The sublimation transfer paper includes a paper substrate having a first side and a second side, and a sublimable ink receptive coating composition on at least one of the first side or the second side of the paper substrate. The sublimable ink receptive coating composition can be applied to the paper substrate at a coat weight of about 1.5 lb./3000 ft² to about 6 lb./3000 ft² based on the dry weight of the coating composition. The sublimable ink receptive coating composition can include at least about 35 wt. % silica based on the dry weight of the coating composition, and at least about 5 wt. % binder based on the dry weight of the coating composition. Methods of sublimation printing and manufacturing sublimation transfer paper are provided.

### FIELD OF THE INVENTION

The present invention relates to sublimation transfer paper, a method for making sublimation transfer paper, and a method for sublimation printing. Sublimation transfer paper can be used for sublimation printing by reverse printing on a surface of the sublimation transfer paper, and combining the reverse printed sublimation transfer paper and a sublimation printing substrate in a sublimator to provide an image on the sublimation printing substrate.

### BACKGROUND

It can be difficult to obtain high fidelity images on certain articles such as textiles (e.g., fabric and clothing) and other articles having a metal, glass, or plastic surface by ink jet printing directly on the article. Sublimation printing techniques are often used to provide images on such articles. Sublimation printing techniques utilize sublimation transfer paper where a desired image is reverse printed on the sublimation transfer paper. The reverse printed sublimation transfer paper and an article to receive the desired images are combined and subjected to a sublimator where sublimable dyes transfer from the sublimation transfer paper to the article.

Sublimable inks that are used for sublimation printing are often provided having dyes that transfer in a sublimator. Reported sublimation temperatures are about 170° C. to about 210° C.

Not all sublimation transfer papers are equally suited for sublimation printing. Certain transfer papers have a tendency to absorb a large amount of sublimable ink and, as a result, require the application of large amounts of sublimable ink to provide a sufficient amount of ink available for transfer. As a result, it can be fairly expensive to use that paper. In addition, other papers may not provide a desired amount of sublimable ink transfer. In such a situation, the resulting image may not be of the quality desired.

Various publications describing transfer paper for use in sublimation printing include, for example, U.S. Pat. No. 6,902,779 to DeVisser et al., U.S. Pat. No. 5,268,347 to Okumura et al., U.S. Pat. No. 4,997,807 to Mukoyoshi et al., U.S. Pat. No. 4,962,080 to Wataenbe, and U.S. Pat. No. 4,731,355 to Iwasaki et al.

### SUMMARY

Sublimation transfer paper is provided according to the present invention. The sublimation transfer paper includes a paper substrate having a first side and a second side, and a sublimable ink receptive coating on at least one of the first side or the second side of the paper substrate. The sublimable ink receptive coating composition can be applied to the paper substrate at a coat weight of about 1.5 lb./3000 ft² to about 6 lb./3000 ft² based on the dry weight of the coating composition. The sublimable ink receptive coating composition comprises at least about 35 wt. % silica based on the dry weight of the coating composition, and at least about 5 wt. % binder based on the dry weight of the coating composition.

Sublimation transfer paper according to the invention can be alternatively characterized as including a paper substrate having a first side and a second side, and a sublimable ink receptive coating composition on at least of one of the first side or the second side of the paper substrate at a coat weight of about 1.5 lb/3,000 ft² to about 6 lb/3,000 ft² based on a dry weight of the coating composition. The sublimable ink receptive coating composition comprises at least about 40 wt. % filler based on the dry weight of the coating composition, wherein at least about 30 wt. % of the filler comprises silica based on the weight of the filler, and at least about 5 wt. % binder based on the dry weight of the coating composition.

A method of sublimation printing on a substrate is provided according to the invention. The method includes steps of reverse printing an image on a sublimable ink receptive coating composition on sublimation transfer paper using a sublimable ink, combining the sublimation transfer paper and a printing substrate, and transferring the reverse printed image from the sublimation transfer paper to the printing substrate to provide the printing substrate having the image applied thereto. The substrate can be, for example, textile (e.g., clothing, banner, or sign), metal, glass, ceramic, or plastic.

A method for making sublimation transfer paper is provided according to the present invention. The method includes steps of manufacturing a paper substrate from a pulp mixture, wherein the paper substrate has a first side and a second side, and applying an aqueous sublimable ink receptive coating composition on at least one of the first side or the second side of the paper substrate, wherein the aqueous sublimable ink receptive coating composition has a solids content of about 5 wt. % to about 70 wt. %. The steps of manufacturing a paper substrate and applying the aqueous sublimable ink receptive coating composition to at least one of the first side and the second side of the paper substrate are steps that can occur during a continuous paper making process.

### BRIEF DESCRIPTION OF THE DRAWING

FIG. 1 is a diagrammatic view of an exemplary process for manufacturing sublimation transfer paper according to the principles of the present invention.

### DETAILED DESCRIPTION

Sublimation printing can provide a high fidelity image on a print substrate. Sublimation printing generally refers to a printing process where a desired image is reverse printed on sublimation transfer paper by a conventional printing technique (e.g., ink jet printing) to provide a reverse printed sublimation transfer paper. The reverse printed sublimation transfer paper can be combined with a print substrate in a sublimator to provide sublimation printing from the reverse printed sublimation transfer paper to the print substrate. Depending on the sublimable ink selected for sublimation printing, the conditions within the sublimator can vary to achieve sublimation printing. Sublimation printing can result from a combination of conditions wherein the conditions include time, temperature, and pressure. The desired level of transfer of sublimable dye can be achieved by selecting the desired time, temperature, and pressure that the sublimation transfer paper and the printing substrate are subjected. For example, it may be possible to achieve transfer at room temperature by adjusting the time and pressure to which the sublimation transfer paper and the printing substrate are subjected. The literature reports sublimation temperatures in excess of 60° C. to achieve transfer of a sublimable dye. Reported sublimation printing temperatures can be in the range of about 170° C. to about 210° C. In general, the surface of the sublimation transfer paper that is printed on can contact the surface of the printing substrate during sublimation printing. The sublimation transfer paper and the printing substrate can be held together by pressure.

An image generally refers to a representation that can include words, numbers, pictures, designs, or any combination thereof. Often, athletic team jerseys include words (e.g., team name and player name), a number (e.g., player number), and a design (e.g., team logo). The words, numbers, and designs, alone or in combination, can be considered an image. In addition, whatever is printed on a sign or banner can be considered an image. The reverse of the image can be applied to sublimation transfer paper and is often referred to as a “reverse image.”

Sublimation printing is advantageous for printing on substrates where it is difficult to achieve a high fidelity image on the substrate by conventional printing techniques such as ink jet printing, flexographic printing, offset printing, and rotary screen printing. For example, the print substrate may be a substrate that has a shape or texture that is difficult to feed to a printer, or it may be a substrate that does not readily receive high fidelity images by conventional printing techniques. Exemplary articles having a print substrate that can be advantageously printed on by sublimation printing include textiles (e.g., fabric and clothing) and articles having a metal, glass, ceramic, or plastic surface. Textiles that are often printed on using sublimation printing include clothing (e.g., t-shirts and jerseys), banners, and signs.

A high fidelity image refers to an image that has a desired level of clarity and a desired color. The desired level of clarity and the desired color can be controlled so that the result is reproducible from print to print. In general, when sublimable ink is printed on sublimation transfer paper, it is often applied as a series of dots where the dots have varying color. As a result of dye transfer in a sublimator, the dyes combine to form the desired color on the printing substrate, and provide the desired image clarity. The sublimation transfer paper can be constructed to improve the resulting image on the sublimation printing substrate. The sublimation transfer paper can be constructed to improve the way the paper receives the sublimable ink as a result of reverse printing, and then releases the sublimable dyes during sublimation printing. Because sublimable inks can be fairly expensive, it is desirable to provide sublimation transfer paper that increases the efficiency of sublimable dye transfer during sublimation printing to decrease the amount of sublimable ink needed to provide a desired image as a result of sublimation printing. The sublimation transfer paper can be provided so that the paper substrate and the sublimable ink receptive coating on the paper substrate receive the sublimable inks and hold the sublimable dyes in a position that allows for efficient transfer of the sublimable dyes during sublimation printing. In theory, the sublimation transfer paper receives the sublimable ink as a result of reverse printing, allows for separation of the ink carrier and the sublimable dye so that the ink carrier moves into the sublimable ink receptive coating and into the paper substrate, and the sublimable dyes remain on or in the sublimable ink receptive coating. By providing the sublimable dyes on or in the sublimable ink receptive coating, the sublimable dyes are readily available for sublimation printing upon reaching sublimation conditions. The separation of the ink carrier and the sublimable dye helps facilitate the drying of the sublimable ink. In addition, the selection of the paper substrate and the sublimable ink receptive coating can help direct the sublimable dyes so they move in a desired direction during sublimation printing (e.g., toward the printing surface and away from the transfer paper) so that the dyes more efficiently reach the printing surface where they provide the desired image. By selecting the paper substrate and the sublimable ink receptive coating, it is possible to decrease the amount of sublimable ink needed to achieve a desired image, and it is possible to improve the resulting image achieved by sublimation printing. Accordingly, selecting the paper substrate and the sublimable ink receptive coating can decrease the amount of sublimable ink needed and can enhance the resulting image quality

Sublimation transfer paper typically receives a fairly large amount of sublimable ink compared with the amount of ink applied to paper as a result of, for example, a desktop computer printer (e.g., an ink jet or laser printer for a business office). In order to provide the desired image by sublimation printing, the sublimable ink is loaded onto the sublimation transfer paper in a relatively large amount. For an exemplary comparison, industrial or commercial ink jet printers that apply sublimable ink generally apply about 5 to about 20 times (typically about 10 to about 15 times) the amount of ink per unit area compared to desktop computer printers. It is expected that desktop printers may be used to apply sublimable ink at rate comparable to conventional desk top computer printers. Nevertheless, sublimation transfer paper that is used in industrial or commercial application typically received a considerable amount of sublimable ink to provide a desired image on a print substrate. The desired image includes a characterization of the clarity as well as the color fidelity. In general, the color fidelity refers to the ability to provide a color match that is as close as desired. It is desirable to provide a sublimation transfer paper that can provide comparable or improved image quality on a print substrate as a result of sublimation printing while receiving less sublimation ink than typically required for sublimation printing.

The sublimation transfer paper can be constructed to receive the sublimable ink and hold the sublimable ink in a manner so that the sublimable ink is available for sublimation printing. The sublimation transfer paper can be characterized as having a paper substrate and a sublimable ink receptive coating on the paper substrate. The sublimable ink receptive coating can be provided on one or both sides of the paper substrate. Typically, sublimation transfer paper is only printed on one side. Accordingly, the sublimation transfer paper only needs to have the sublimable ink receptive coating on the side that receives the sublimable ink. The sublimable ink receptive coating is provided to receive the sublimable ink when it is applied to the sublimation transfer paper. To reduce the potential of the paper to curl, the other side of the paper substrate can receive a coating that may include a sizing agent (e.g., a size coat). The size coat can contain some type of visual indicator (e.g., a pigment or dye) that allows the user of the sublimation transfer paper to immediately appreciate which side of the sublimation transfer paper contains the sublimable ink receptive coating and is the side intended to receive the sublimable ink. The pigment or dye that is provided as part of the size coat can be selected so that it does not transfer during sublimation processing.

The paper substrate and the sublimable ink receptive coating provided on the surface of the paper substrate can be selected to provide desired receipt of the sublimable ink, and desired release or transfer of the sublimable dye during sublimation printing. An advantage of the sublimable ink receptive coating according to the invention is that it can be applied to the paper substrate “on machine.” The reference to “on machine” refers to the application of the coating during the paper making process. Accordingly, as the paper is made, the coating can be applied relatively soon after the paper substrate is formed. By applying the sublimable ink receptive coating “on machine” it is possible to avoid the costs associated with “off machine” processing where the paper substrate is shipped to another location for application of a coating thereon.

Sublimable ink refers to a material having a colorant (e.g., sublimable dye) and a carrier. The carrier allows the sublimable dye to be applied or printed onto the sublimation transfer paper. The sublimable dye is typically a solid at room temperature. Because the sublimable dye is typically considered a solid at room temperature, it is difficult to print the solid, sublimable dye onto a substrate without the use of the carrier. Once the sublimable ink is printed onto the sublimation transfer paper, it is desirable to separate the sublimable dye from the carrier to facilitate drying and so that the sublimable dye is concentrated at or near the paper surface. In general, the sublimation transfer paper can be constructed to pull the carrier away from the sublimable dye so that the sublimable dye remains at or near the paper surface and is available for sublimation printing. If the carrier moves into the paper too quickly, sufficient separation of the carrier from the sublimable dye may not take place. If the carrier does not move into the paper quickly enough, the sublimable ink may have a tendency to smear or run. Accordingly, the selection of the paper substrate and the coating can assist in the ability of the sublimation transfer paper to handle the sublimable ink and provide a desired high fidelity image. Furthermore, the selection of the paper substrate and the coating can provide a reduction in the amount of sublimable ink needed to provide the desired image compared with prior transfer papers.

Exemplary sublimable dyes that can be found in sublimable inks include, for example, azo dyes, nitro dyes, anthraquinone dyes, quinloine dyes, basic dyes such as triphenylmethane dyes, and flouran dyes, oil soluble dyes, and various other types of dyes. The sublimable dye can be provided so that it resists transfer under normal handling conditions at room temperature. Once a transfer temperature is achieved, the sublimable dye can transfer to the sublimation printing substrate. The precise mechanism of transfer is not necessarily clear. It is expected that at least a portion of the sublimable dye gasifies and transfers as a gas. However, it is possible that some of the sublimable dye may liquefy and transfer as a liquid. Furthermore, the temperature, pressure, and time available for sublimation printing can affect the extent of transfer. It is expected that sublimation temperatures within a sublimator can be at least about 60° C. Published reports identify a typical temperature range for sublimation printing of about 170° C. to about 210° C.

The sublimable ink can be provided as a water-based ink, an organic solvent-based ink, or as an oil-based ink. The three types of sublimable inks are commonly available. In the case of a water-based ink, the carrier includes water. In the case of an organic solvent-based ink, the carrier includes an organic solvent. An exemplary organic solvent used in sublimable inks include low boiling solvents that have a tendency to evaporate. Oil-based inks can include a high boiling oil such as isoparaffinic hydrocarbons or oils, examples of which include those available under the names Isopar M and Isopar K. The paper substrate and the sublimable ink receptive coating can be adapted to preferentially accept any of these types of sublimable inks.

### Paper Substrate

The paper substrate of the sublimation transfer paper can be selected so that it has properties that are desirable for sublimation transfer paper. In general, sublimation transfer paper should be sufficiently processable when processed through a printer for application of the sublimable ink thereto. In addition, the sublimation transfer paper should be sufficiently processable so that it can be combined with the sublimation print substrate and subjected to sublimation printing. If the paper substrate is too flimsy or too rigid, it may be difficult to handle for printing.

The openness of the paper substrate can be selected to facilitate drying of the sublimable ink and to resist penetration of sublimed dye vapor to encourage the sublimed dye vapor to move toward the printing substrate that receives the final image rather than in a direction away from the printing substrate such as into the paper substrate. Accordingly, it is desirable to provide a sufficient openness so that the carrier penetrates into the paper substrate while the sublimable dye remains at or on the sublimable ink receptive coating. Furthermore, the openness should be sufficiently low so that sublimed dye resists movement into the paper substrate and is instead encourage to move toward the printing substrate to generate the final image.

The paper substrate can be prepared from natural fiber, synthetic fiber, or a mixture of natural fiber and synthetic fiber. Natural fiber refers to fiber formed from plants or animals. Natural fibers are not fibers that are formed as a result of extrusion or spinning. The natural fibers can be obtained from a source of fiber using techniques such as chemical pulping, chemical mechanical pulping, semi chemical pulping, or mechanical pulping. Natural fibers from plants are often referred to as cellulosic fibers. Exemplary natural fibers that can be used to form the base sheet include wood fibers and non-wood natural fibers such as vegetable fibers, cotton, various straws (e.g., wheat and rye), various canes (e.g., bagasse and kenaf), silk, animal fiber, (e.g., wool), grasses (e.g., bamboo, etc.), hemp, corn stalks, abaca, eucalyptus, etc. Examples of synthetic fibers that could be used for the base sheet include polyacrylic fiber, polyethylene fiber, polypropylene fiber, polylactide fiber, rayon, and nylon fiber.

Wood fiber can be obtained from wood pulp, which can include hardwood fibers, softwood fibers, or a blend of hardwood fibers and softwood fibers. The pulp can be provided as cellulose fiber from chemical pulped wood, and can include a blend from coniferous and deciduous trees. By way of example, wood fibers can be from northern hardwood, northern softwood, southern hardwood, southern softwood, or any blend thereof. Hardwood fibers tend to be more brittle but are generally more cost effective for use because the yield of pulp from hardwood is higher than the yield of pulp from softwood. Softwood fibers have desired paper making characteristics but are generally more expensive than hardwood fibers.

The natural fibers can be extracted with various pulping techniques. For, example, mechanical or high yield pulping can be used for stone ground wood, pressurized ground wood, refiner mechanical pulp, and thermomechanical pulp. Chemical pulping can be used incorporating kraft, sulfite, and soda processing. Semi-chemical and chemi-mechanical pulping can also be used which includes combinations of mechanical and chemical processes to produce chemi-thermomechanical pulp. Natural fibers can be bleached or unbleached.

The pulp can include a recycle source for reclaimed fiber. Exemplary recycle sources include post-consumer waste (PCW) fiber, office waste, and corrugated carton waste. Post-consumer waste fiber refers to fiber recovered from paper that is recycled after consumer use. Office waste refers to fiber obtained from office waste, and corrugated carton waste refers to fiber obtained from corrugated cartons. Additional sources of reclaimed fiber include newsprint and magazines. Reclaimed fiber can include both natural and synthetic fiber. Incorporation of reclaimed fiber in the base can aid in efficient use of resources and increase satisfaction of the end user of the transfer paper.

In general, hard wood fibers have a tendency to enhance tightness and resistance to penetration. Soft wood fibers have a tendency to provide strength and facilitate runability of the paper substrate during formation. Although the paper substrate can be manufactured from 100% hard wood fibers or 100% soft wood fibers, it is common practice to provide a blend of hard wood fiber and soft wood fiber. The blend can be expressed in a weight percent ratio, based on the fiber content, of hard wood fibers to soft wood fibers. An exemplary weight percent ratio of hard wood fibers to soft wood fibers for an exemplary paper substrate can be at least about 0.5:1 to about 6:1, and can be about 2:1 to about 5:1. The amount of soft wood fiber in an exemplary paper substrate can be characterized as about 0% to about 80 wt. %, and the amount of hard wood fiber in an exemplary paper substrate can be provided at a level of about 0 wt. % to about 100 wt. %. The fibers used to form the paper substrate can include fiber resulting from a recycle such as, for example, a pre-consumer recycle. In general, a pre-consumer recycle refers to trimmings or fiber recovered during the paper making process.

The refining of the fibers can be selected to enhance formation and fiber development. In general, if the fibers are too refined, the resulting substrate may not exhibit sufficient porosity and, as a result, the sublimable ink may not dry quickly enough. Refining the fibers helps with formation of the paper substrate during the paper making process, and contributes to the holdout of the sublimable ink receptive coating that is applied to the paper substrate on the paper making machine. The level of refining can be selected to help direct the sublimable dye away from the base sheet and toward the sublimation printing substrate during sublimation printing. That is, by selecting the level of refining, it is believed that the movement of the sublimable dye during sublimation printing can be better directed toward the sublimation printing substrate to provide a more focused delivery onto the sublimation printing substrate and thereby provide a desired image with less dye than if the dye went in all directions equally. The level of refining can be characterized by Canadian Standard Freeness (CSF). In general, a higher Canadian Standard Freeness value refers to fiber that is less refined, and a lower Canadian Standard Freeness value refers to fiber that is more refined. The level of refining of the fibers for the sublimation transfer paper can be characterized as moderately refined whereas many products used as sublimation transfer paper can be characterized as minimally refined. An exemplary characterization of refining for fiber that can be used for forming the paper substrate can be about 100 CSF to about 600 CSF. Fiber that can be used for forming the paper substrate can have a Canadian Standard Freeness value of about 300 CSF to about 500 CSF.

The paper substrate can be provided having a weight that enables the sublimation transfer paper to be processed through printing equipment and utilized for sublimation printing, and that facilitates drying of the ink (e.g., separation of the carrier from the dye). For example, the paper substrate can be provided having a weight of about 20 lb/3,000 ft² to about 200 lb/3,000 ft², and can have a weight of about 30 lb/3,000 ft² to about 120 lb/3,000 ft². The weight of the paper substrate can be referred to as a basis weight. An additional exemplary basis weight range for the paper substrate can be about 55 lb/3,000 ft² to about 85 lb/3,000 ft².

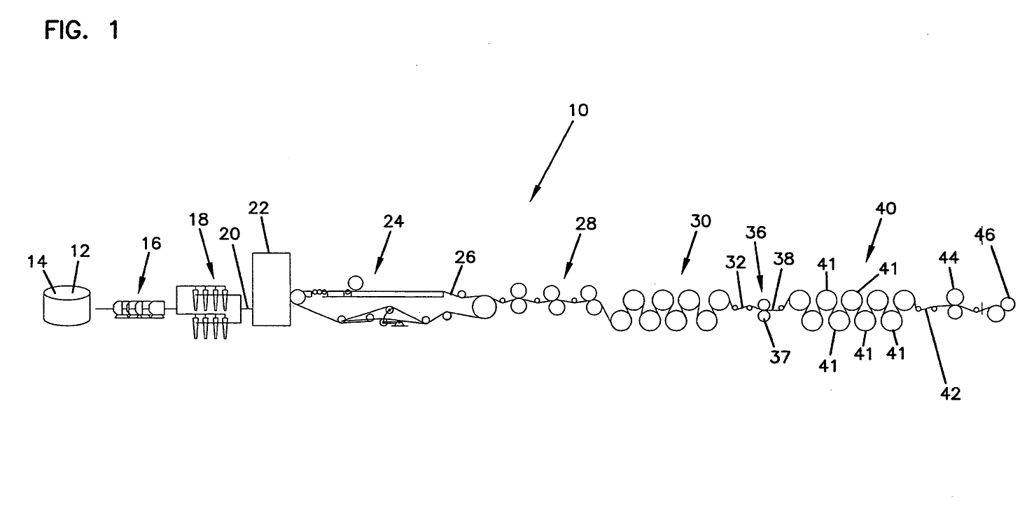

Now referring to FIG. 1, a schematic diagram showing a process for the manufacture of sublimation transfer paper product is provided at reference number 10. The process 10 includes many of the operations carried out in commercial paper making facilities. The equipment used in a particular operation may vary from facility to facility, but it is expected that many of the general operations will be present. In addition, it should be understood that various additional steps, if desired, can be included in the process.

The starting material generally includes wood pulp 14, but could be any of the materials discussed above. Wood pulp 14 can be processed through a refining operation 16 and through a cleaning operation 18 to form cleansed pulp 20. Cleansed pulp 20 can be applied through a head box 22 onto a paper making machine 24, such as a Fourdrinier machine to provide a base sheet 26. Additives can be added prior to or at head box 22, and can be added prior to or during formation of base sheet 26.

The addition of additives prior to or at head box 22, or prior to or during formation of base sheet 26 can be referred to as “wet end chemistry.” Wet end additives can be provided for sizing, porosity wet strength, water-resistance, oil-resistance, holdout, or mixture thereof. Exemplary water-resistance additives include sizing agents. The sizing agent can be provided to assist with water holdout and to provide water barrier properties. In addition, the sizing agent helps control the rate of water penetration into the paper substrate. When using a water-based sublimable ink, it may be desirable to provide a sufficient amount of sizing agent to help control the rate of water penetration into the paper substrate when the sublimable ink is applied to the sublimation transfer paper. Exemplary sizing agents include rosin, alkyl ketene dimer (AKD), alkenyl succinic anhydride (ASA), stearylated melamine, wax emulsions, styrene maleic anhydride (SMA), latex, ethylene acrylic acid (EAA), cationic styrene-based polymers, or mixtures thereof. Wet end filler can be used to provide opacity, sheet stability, and substrate openness. In general, the wet and filler can help provide the paper substrate with a desired amount of openness to allow the carrier of the sublimable ink to penetrate into the paper substrate. In addition, the wet end filler helps to control the dry time and enhance the paper substrate dimensional stability. Exemplary fillers include precipitated calcium carbonate and clays (e.g., kaolin clay). A retention aid can be provided at the wet end to assist with retention of the wet and filler within the paper substrate. The retention aid can include coagulants, flocculants, and mixtures of coagulants and flocculants. In general, the retention aid can be provided to help bind the fibers together and to help bind the filler to the fiber.

The wet end chemistry can, if desired, include an oil-resistant additive, a wet strength additive, or both. Exemplary oil-resistant additives include sizing agents such as fluorochemicals. Exemplary wet strength additives include urea formaldehyde resins, melamine formaldehyde resins, polyamides, polyethyleneimine resins, wet end latexes, size press latexes, or mixtures thereof. Exemplary polyamides include polyamide epichlorohydrin resins (PAE) such as that available under the name KYMENE from Hercules, and glyoxylated vinylamides such as that available under the name PAREZ 631 NC.

The amount of the sizing agent added at the wet end can be selected depending upon the sublimable ink intended to be used with the sublimation transfer paper. In the case of an aqueous-base sublimable ink, it is generally desirable to provide a sufficient amount of the sizing agent so that the water from the aqueous-based sublimable ink does not penetrate into the paper substrate too quickly. Accordingly, when the sublimation transfer paper is provided for use with an aqueous-based sublimable ink, the paper substrate preferably includes at least one pound sizing agent per ton of fiber. Sublimation transfer paper for use with sublimable inks that are organic solvent-based or oil-based can tolerate the use of a lower amount of wet end sizing agent. In general, the upper amount of sizing agent can be determined by cost and the desire for the sizing agent not to plate out during wet end chemistry. In general, this corresponds to an upper limit of about 4 pounds sizing agent per ton of fiber. The amount of the wet end filler can be selected so that the sublimation transfer paper provides desired ink drying and dye transfer. In general, it can be desirable to provide the paper substrate with an amount of filler of about 80 pound/ton to about 240 pound/ton, and preferably about 120 pound/ton to about 200 pound/ton. It should be understood that the characterization of pound/ton refers to pounds dry filler per ton dry paper.

Referring again to FIG. 1, the base sheet 26 can be processed through a wet press section 28 to remove water, and then through a dryer section 30 to further reduce the water content and provide a paper substrate 32 having a desired water content. Paper substrate 32 can be taken up in a roll and stored or shipped to another location.

The sublimable ink receptive coating can be applied to the paper substrate “on machine” or “off machine.” The sublimable ink receptive coating can be applied to the paper substrate 32 “on machine” at the size press 36. In general, the size press 36 is shown as a puddle size press 37 where both sides of the paper substrate 32 are treated with one or more compositions. Although a size press is exemplified in FIG. 1, any type of coater can be used for application of the sublimable ink receptive coating or the size coating composition, or both. Exemplary coaters include puddle coaters, film coaters, blade coaters, gate roll coaters, three roll coaters, etc. Furthermore, the sublimable ink receptive coating can be applied to one side of the paper substrate 32, and a size composition can be applied to the other side of the paper substrate 32. It may be desirable to apply the sublimable ink receptive coating to the smoother surface of the paper substrate. The smoother surface of the paper substrate is often the felt side. The wire side of the paper substrate 32 is often considered to be rougher, although that is not necessarily the case. The sublimable ink receptive coating can be applied to either or both of the felt side or the wire side, but it is expected that it will typically be applied to the felt side. A different composition, such as a sizing composition can be applied to the side opposite the side of the paper substrate that receives the sublimable ink receptive coating. Providing a coating composition on the side of the paper substrate opposite the sublimable ink receptive coating can help reduce the tendency of the sublimation transfer paper to curl. The sizing composition can be provided as a conventional sizing composition or as some other coating composition.

The resulting coated paper substrate 38 can be processed through a dryer section 40 to remove water to provide the sublimation transfer paper 42. The sublimation transfer paper 42 can be calendared at a calendar roll 44 and can be taken up in a roll 46.

Dryer section 40 can be provided as a contact dryer section because of the use of contact dryers 41 to drive water off from coated base substrate 38. Contact dryers 41 can include heated rolls that contact the surface of coated substrate 38 containing the coating composition. The heated rolls can be provided as steam cans, which are fairly commonly used in paper making. In general, steam runs through the steam cans to provide heating. Although coated substrate 38 can be dried on a contact dryer, non-contact dryers can be used to dry the coated substrate. Exemplary non-contact dryers include air dryers, infrared dryers, and gas dryers. It is convenient to use contact dryers for drying the coated substrate because paper making equipment commonly utilize contact dryers.

### Sublimable Ink Receptive Coating

The sublimable ink receptive coating refers to the coating that is provided on the surface of the paper substrate for receipt of the sublimable ink. The sublimable ink receptive coating can be referred to as the functional coating because it functions to hold the dye in a position available for sublimation printing. The sublimable ink receptive coating can be referred to more simply as the coating.

An advantage of the sublimation transfer paper according to the present invention is that the sublimable ink or receptive coating can be applied “on machine” during the paper making process. Prior art sublimation print coated papers are often prepared by applying a relatively large amount of coating to a paper substrate “off machine.” Because a relatively large amount of coating is applied to the paper substrate, it is often necessary to utilize coating equipment that can apply a relatively thick coating composition. Such techniques are usually carried out “off machine” and require additional handling of the paper substrate and, possibly, transportation of the paper substrate for the coating “off machine.”

The sublimable ink receptive coating applied to the paper substrate according to the invention can be characterized as a highly functional composition and can be applied at a relatively low coat weight and, therefore, applied “on machine.” The sublimable ink receptive coating can be applied to the paper substrate at a range of about 1.5 lb/3000 ft² to about 6 lb/3000 ft², and can preferably be applied at a coat weight of about 3 lb/3000 ft² to about 5 lb/3000 ft². The coat weight refers to the solids weight of the composition. When the sublimable ink receptive coating composition is applied to the paper substrate, it can be applied as an aqueous composition having a solids content that provides the resulting sublimation transfer paper with the desired coat weight of the sublimable ink receptive coating. If the aqueous sublimable ink receptive coating composition is provided with a solids content that is too low or too high, then too little or too much of the solids may be applied. An exemplary solids range for the aqueous sublimable ink receptive coating composition can be about 5 wt. % to about 70 wt. % solids. Additional exemplary ranges include about 20 wt, % to about 50 wt. % solids, or about 30 wt. % to about 45 wt. % solids.

The sublimable ink receptive coating composition includes, as solid components, at least a filler and a binder. The filler provides the desired properties of holding the sublimable dye in place and allowing for the separation and absorption of the carrier from the sublimable dye. The binder helps hold the filler to the paper substrate. The applicants have found that silica (preferably amorphous silica) can be used as a filler in an amount to provide desired properties. The sublimable ink receptive coating composition can include silica at a level of at least about 30 wt. % and preferably at least about 35 wt. % based on the solids weight of the composition. In addition, the coating composition can contain about 35 wt. % to about 90 wt. % silica based on the solids weight of the composition. Furthermore, the sublimable ink receptive coating can include silica in an amount of about 40 wt. % to about 80 wt. % based on the solids weight of the composition. Other fillers can be used in addition to silica. The sublimable ink receptive coating can include a sufficient amount of binder to hold the filler to the paper substrate. The sublimable ink receptive coating can include at least about 5 wt. % binder, and preferably about 5 wt. % to about 40 wt. % binder, and preferably about 10 wt. % to about 30 wt. %, based on the solids weight of the composition.

The sublimable ink receptive coating composition can additionally be characterized by the amount of filler and the weight percent of the filler that is silica. The sublimable ink receptive coating can be provided containing about 40 wt. % to about 95 wt. % filler, based on the solids weight of the coating composition, and about 5 wt. % to about 40 wt. % binder based on the solids weight of the composition. The coating composition can include about 50 wt. % to about 90 wt. %, or about 60 wt. % to about 80 wt. % of the filler based on the solids weight of the coating composition. In addition, the coating composition can contain about 10 wt. % to about 35 wt. %, or about 15 wt. % to about 30 wt. % of the binder, based on the solids weight of the coating composition. The filler can include at least about 30 wt. % silica based on the weight of the filler component. Preferably, the filler contains at least about 40 wt. % silica, and preferably at least about 50 wt. % silica based on the weight of the filler. The filler can contain up to 100% silica based on the weight of the filler.

Examples of suitable filler materials include silica (e.g., amorphous silica, calcined silica, fumed silica), clays (e.g., calcined clay), calcium carbonate, talc, kaolin, and other known fillers. Silica filler is a preferred filler, and may be combined with one or more additional fillers such as clay and calcium carbonate. Amorphous silica is a preferred silica.

The binder can be provided as a polymeric material. Exemplary binders include polyvinyl alcohol, acrylics, latexes (including acrylic latex), natural polymer (e.g., starch) or mixtures thereof. The binder may be solvent based (e.g., organic solvent or water based) and preferably can be readily dried by conventional paper making processing. The polymers additionally, in some embodiments, inhibit dusting during the printing process.

An exemplary sublimable ink receptive coating can include about 60 wt. % to about 75 wt. % filler, and about 20 wt. % to about 40 wt. % binder, with no more than about 10 wt. % of other additives. An additional exemplary sublimable ink receptive coating composition can include about 65 wt. % to about 75 wt. % filler, and about 20 wt. % to about 35 wt. % binder, with no more than about 5 wt. % of other additives. An additional exemplary sublimable ink receptive coating composition can include no more than about 80 wt. % filler, no more than about 33 wt. % binder, and no more than about 6.5 wt. % other additives (e.g., no more than about 5 wt. % sizing agent, such as alkyl ketene dimer, and no more than about 1.5 wt. % rheology modifier).

An exemplary sublimable ink receptive coating composition can include about 70 wt. % filler (e.g., about 45 wt. % silica and about 25 wt. % other fillers) and about 30 wt. % binder. For example, the coating can include about 45 wt. % silica, about 9 wt. % calcium carbonate, about 15.5 wt. % clay, and about 30% of binder. Another coating can include about 75 wt. % filler (e.g., about 45 wt. % silica and about 30 wt. % other fillers) and about 22.5 wt. % binder. For example, the coating can include about 45 wt. % silica, about 10 wt. % calcium carbonate, about 20 wt. % clay, and about 22.5 wt. % of binder. Yet another exemplary coating can include about 73 wt. % filler (e.g., about 45 wt. % silica and about 28 wt. % other fillers) and about 22.5 wt. % binder. For example, the coating can include about 45 wt. % silica, about 10 wt. % calcium carbonate, about 18 wt. % clay, and about 22.5 wt. % of binder. Of course other compositions are within the scope of this disclosure. For example, coating can have about 80 wt. % total filler, with no more than 50 wt. % being silica (e.g., amorphous silica), about no more than 21 wt % being clay (e.g., calcined clay) and no more than about 11 wt. % being calcium carbonate (e.g., precipitated calcium carbonate).

The sublimable inks that are used both in contact printing processes and in contactless printing processes can be oil-based, water-based, or solvent-based. Oil-based inks are produced with oil, such as mineral oil, vegetable oil or soybean oil, as the main liquid composition in which the dye particles are dispersed. Water-based inks are inks produced with water as main liquid component, in which the dye particles are dispersed in the liquid. Similarly, solvent-based inks are inks produced with organic solvent (e.g., 2-butoxyethyl acetate, cyclohexanone, vinyl chloride, vinyl acetate, decane) as the main liquid component in which the dye particles are dispersed. In some embodiments, oil may present in solvent-based inks. Thickeners may be added to any of the inks to enable processing the ink as a pasty mass, if desired. It may be desired to alter the composition of the ink receptive layer, depending on the composition of the ink being used. For example, papers for use with oil-based inks often have a higher binder level, to inhibit dusting during the printing process.

The side of the paper substrate opposite the sublimable ink receptive coating composition (e.g., the wire side) can be left uncoated or can have a coating thereon. The side of the paper substrate opposite the sublimable ink receptive coating composition can include a coating such as a conventional sizing composition to provide the sublimation transfer paper with enhanced stability. Sublimation transfer paper that includes a coating on only one side may have an increased tendency to curl. The coating opposite the sublimation ink receptive coating composition can be another sublimation ink receptive coating composition (the same or different than applied on the first side). In addition, the side of the paper substrate opposite the sublimable ink receptive coating composition can include a marker for identifying the paper. The marker may be provided to identify the weight of the paper or the type of paper useful for certain types of sublimable inks. Furthermore, the marker can indicate the side that is not supposed to receive the sublimable ink for reverse printing. The marker can identify the paper weight, the paper thickness, or the paper grade. Various markers can include alpha-numeric indicia, patterns, and colors. Color can be a preferred marker. People using the paper can identify the color on the side of the sublimation transfer paper opposite the sublimable ink receptive coating, and understand that the paper is designed for use with a particular type of sublimable ink. For example, a first paper (e.g., intended for use with water-based ink) could have a green coating, whereas a second paper (e.g., intended for use with solvent-based ink) could have a red coating.

The sublimation transfer paper can have a paper substrate and a sublimable ink receptive coating (e.g., on one side) that provides a desired porosity to achieve a desired, high transfer efficiency. Improving the transfer efficiency can result in improvement (e.g., increase) in color density for the resulting printed product. The higher the color density, the more preferred the product. The transfer paper can have a porosity (measured with a Hagerty Porosity meter) of about 10 to about 1000 sec/100 ml air, and preferably about 50 to about 400 sec/ml air. The transfer paper can have a Hagerty porosity of about 100 to about 250 sec/100 ml air. The Hagerty Porosity meter measures the number of seconds it takes for 100 ml of air to pass through the substrate. The selection of the paper substrate (e.g., fibers and openness) and the selection of the sublimable ink receptive coating can effect the Hagerty Porosity meter value. For example, increasing the amount of a coating on a paper substrate can cause a decrease in Hagerty Porosity meter value. The sublimation transfer paper according to the invention can be characterized as having a relatively light sublimable ink receptive coating because of the selection of the components of the sublimable ink receptive coating. Other coating, such as, conventional clay coatings can be provided at a heavier weight or in greater thickness. However, the heavier or thicker clay coatings may result in a sacrifice in porosity and, therefore, a sacrifice in color density. Another advantage of the sublimation transfer paper according to the invention is the ability to provide a relatively thin layer of the sublimable ink receptive coating on the paper substrate to provide a desired porosity and to achieve a desired image as a result of transfer printing.

The sublimation transfer paper can provide a color profile that results in a hire black density on the resulting image compared with the use of presently available commercial transfer papers. In the case of the sublimation transfer paper constructed for use with oil-based sublimable inks, the color profile can provide at least 4% higher black density for the resulting image compared currently available and tested sublimation transfer paper. Furthermore, the sublimation transfer paper can provide a utilization of less ink to achieve a comparable or improved image quality as a result of sublimation printing compared with tested commercially available sublimation transfer paper. In the case of sublimation transfer paper constructed for use with oil-based sublimation ink, the amount of ink used to provide a comparable or improved image can be about 15% to about 20% less compared with the amount of ink used with tested commercially available sublimation transfer paper.

### EXAMPLES

Three sublimation paper products were prepared. Sublimation transfer paper #1 was prepared for use with an oil-based sublimable ink. Sublimation transfer paper #2 was prepared for use with a water-based sublimable ink. Sublimation transfer paper #3 was prepared for use with an organic solvent-based sublimable ink.

The paper substrate for the three sublimation transfer paper products was prepared from a furnish that includes 60% Sappi Wet Lap Hardwood (450 csf), 20% Roburflash Northern Softwood (325 csf) and 20% internal broke. Internal broke refers to pre-consumer recycle pulp that results from trimming of paper during the paper making process. As part of the wet end chemistry, to each ton of the furnish was added 10-20 pounds of sodium bicarbonate and 75 cc blue pigment (Sensient Blue ST-14). For each ton of paper, the size coat includes 4 pounds sizing agent (Hercules Hercon 79 AKD), 7500 cc/min precipitated calcium carbonate (Specialty Minerals Albacar HO). Various retention aid chemicals, which are well known in the paper business, were added to the size coat.

The paper substrate was prepared on a conventional 140 inch wide paper making machine. The machine included a Fourdrinier forming section with air padded headbox, 2 forming section presses, 3 roll transfer film coater for the felt side, 3 roll transfer film coater for the wire side, IR heater bank after the coater and prior to section dryers, and steel/steel on machine calender rolls.

A sublimable ink receptive coating was applied to the paper substrate to form each of the three sublimation transfer paper products. The compositions were applied to the felt side of the paper substrate. The compositions applied are reported in Tables 1-3.

TABLE 1
Sublimation print coating composition for oil-based printing system

| | | | dry | dry |
|---|---|---|---|---|
| | Wet weight | % | weight | weight |
| Component | (g) | solids | (g) | % |
| Water | 136.9 | 0 | 0 | 0 |
| clay (Hubertex clay slurry) | 486.0 | 59 | 286.8 | 15.5 |
| calcium carbonate (Hydrocarb | 166.5 | 100 | 166.5 | 9 |
| PG3) | | | | |
| silica (Silcron G-100 slurry) | 2601.6 | 32 | 832.5 | 45 |
| polyvinyl alcohol (Celvol 103) | 860.5 | 21.5 | 185.0 | 10 |
| acrylic emulsion (Hycar | 711.5 | 52 | 370.0 | 20 |
| 26256) | | | | |
| thickener (Alcogum L-237) | 37.0 | 25 | 9.3 | 0.5 |

TABLE 2
Sublimation print coating composition for water-based printing system

| | | | dry | dry |
|---|---|---|---|---|
| | Wet weight | % | weight | weight |
| Component | (g) | solids | (g) | % |
| Water | 3.8 | 0 | 0 | 0 |
| clay (Hubertex clay slurry) | 470.2 | 59 | 277.4 | 19 |
| calcium carbonate (Hydrocarb | 146.0 | 100 | 146.0 | 10 |
| PG3) | | | | |
| silica (Silcron G-100 slurry) | 2190.0 | 30 | 657.0 | 45 |
| polyvinyl alcohol (Celvol 103) | 466.0 | 23.5 | 109.5 | 7.5 |
| acrylic emulsion (Hycar | 421.2 | 52 | 219.0 | 15 |
| 26256) | | | | |
| thickener (Alcogum L-237) | 29.2 | 25 | 7.3 | 0.5 |
| strengthener (Hercules Hercon | 273.8 | 16 | 43.8 | 3 |
| 100) | | | | |

TABLE 3
Sublimation print coating composition for
organic-solvent based printing system

| | | | dry | dry |
|---|---|---|---|---|
| | Wet weight | % | weight | weight |
| Component | (g) | solids | (g) | % |
| Water | 42.6 | 0 | 0 | 0 |
| clay (Hubertex clay slurry) | 219.7 | 59 | 129.6 | 18 |
| calcium carbonate (Hydrocarb | 72.0 | 100 | 72.0 | 10 |
| PG3) | | | | |
| silica (Silcron G-100 slurry) | 1012.5 | 32 | 324.0 | 45 |
| polyvinyl alcohol (Celvol 103) | 251.2 | 21.5 | 54.0 | 7.5 |
| acrylic emulsion (Hycar | 207.7 | 52 | 108.0 | 15 |
| 26256) | | | | |
| thickener (Alcogum L-237) | 14.4 | 25 | 3.6 | 0.5 |
| strengthener (Hercules Hercon | 180.0 | 16 | 28.8 | 4 |
| 100) | | | | |

The sizing composition reported in Table 4 was applied to the wire side of each of the three sublimation transfer paper products. A different color tint was added to the sizing composition for application to each of the three different sublimation transfer paper products in order to differentiate the three based upon whether the sublimation transfer paper was intended to be used with an oil-based sublimable ink, a water-based sublimable ink, or an organic solvent-based sublimable ink. The percent solids was selected as 25%, and the viscosity was about 1,000 CPS at 20 RPM and 130° F.

TABLE 4
Sizing composition

| Component | Amount |
|---|---|
| hydroxyethylated cornstarch (Penford | 80.1 |
| Products Penford Gum 280) | |
| alginate (ISP Kelgin MDH) | 2.2 |
| clay (Engelhard #2) | 16.7 |
| insolubilizer and crosslinking | 1.0 |
| agent (Bercen Berset 2115) | |

The physical properties of the three sublimation transfer paper products are reported in Table 5.

TABLE 5
Physical properties of sublimation transfer paper

| | |
|---|---|
| Basis weight of base sheet | 72.5 pounds/3000 ft² |
| Caliper | 5.6 to 6.5 mils |
| Finished Moisture | 5.5% |
| Hagerty Porosity | 100 to 300 seconds/100 cc air |
| Hercules Size Test (HST) - Felt Side | Up to 500 seconds |
| (#2 Test Solution, 80% Reflectance) | |
| Felt Side Coat Weight | Up to 5.5 pounds/3000 ft² |
| Wire Side Coat Weight | Up to 2.0 pounds/3000 ft² |
| Felt Side Parker Print Smoothness | 5.5 to 8.5 microns |
| Sheet ash | 7 to 15% |

The above specification, examples and data provide a complete description of the manufacture and use of the composition of the invention. Since many embodiments of the invention can be made without departing from the spirit and scope of the invention, the invention resides in the claims hereinafter appended.

What is claimed:

1. Sublimation transfer paper comprising:
(a) paper substrate having a first side and a second side; and
(b) a sublimable ink receptive coating composition on at least of one of the first side or the second side of the paper substrate at a coat weight of about 1.5 lb/3,000 ft² to about 6 lb/3,000 ft² based on a dry weight of the coating composition, the sublimable ink receptive coating composition comprising:
(i) at least about 35 wt. % silica based on the dry weight of the coating composition; and
(ii) at least about 5 wt. % binder based on the dry weight of the coating composition.

2. Sublimation transfer paper according to claim 1, wherein the coating composition comprises about 40 wt. % to about 80 wt. % silica based on the dry weight of the coating composition.

3. Sublimation transfer paper according to claim 1, wherein the coating composition comprises about 5 wt. % to about 40 wt. % binder.

4. Sublimation transfer paper according to claim 1, wherein the coating composition further comprises filler comprising at least one of clay, calcium carbonate, or a mixture of clay and calcium carbonate.

5. Sublimation transfer paper according to claim 1, further comprising a composition on the other of the first side or the second side of the base sheet, wherein the composition comprises a non-sublimable dye.

6. Sublimation transfer paper according to claim 5, wherein the non-sublimable dye identifies the grade of the sublimation transfer paper.

7. Sublimation transfer paper according to claim 1, wherein the paper substrate has a basis weight of about 20 lb/3,000 ft² to about 200 lb/3,000 ft^{2.}

8. Sublimation transfer paper according to claim 1, wherein the paper substrate comprises paper formed from fiber having a level of refining of about 100 CSF to about 800 CSF.

9. Sublimation transfer paper according to claim 1, wherein the paper substrate comprises paper formed from fiber having a level of refining of about 300 CSF to about 500 CSF.

10. Sublimation transfer paper according to claim 1, wherein the sublimable ink receptive coating is provided at a coat weight of about 3 lb./3000 ft² to about 5 lb./3000 ft² based on the dry weight of the coating composition.

11. Sublimation transfer paper according to claim 1, wherein the sublimation transfer paper has a Hagerty Porosity of about 10 sec/100 ml air to about 1000 sec/100 ml air.

12. Sublimation transfer paper according to claim 1, wherein the sublimation transfer paper has a Hagerty Porosity of about 50 sec/100 ml air to about 400 sec/100 ml air.

13. Sublimation transfer paper comprising:
(a) paper substrate having a first side and a second side; and
(b) a sublimable ink receptive coating composition on at least of one of the first side or the second side of the paper substrate at a coat weight of about 1.5 lb/3,000 ft² to about 6 lb/3,000 ft² based on a dry weight of the coating composition, the sublimable ink receptive coating composition comprising:
(i) at least about 40 wt. % filler based on the dry weight of the coating composition, wherein at least about 30 wt. % of the filler comprises silica based on the weight of the filler; and
(ii) at least about 5 wt. % binder based on the dry weight of the coating composition.

14. Sublimation transfer paper according to claim 13, wherein the coating composition comprises about 40 wt. % to about 95 wt. % filler based on the dry weight of the coating composition.

15. Sublimation transfer paper according to claim 13, wherein the silica comprises amorphous silica.

16. Sublimation transfer paper according to claim 13, wherein the filler comprises clay, calcium carbonate, or a mixture of clay and calcium carbonate.

17. Sublimation transfer paper according to claim 13, wherein the paper substrate has a basis weight of about 20 lb/3,000 ft² to about 200 lb/3,000 ft^{2.}

18. Sublimation transfer paper according to claim 13, wherein the paper substrate comprises paper formed from fiber having a level of refining of about 100 CSF to about 800 CSF.

19. Sublimation transfer paper according to claim 13, wherein the paper substrate comprises paper formed from fiber having a level of refining of about 300 CSF to about 500 CSF.

20. Sublimation transfer paper according to claim 13, wherein the sublimable ink receptive coating is provided at a coat weight of about 3 lb./3000 ft² to about 5 lb./3000 ft² based on the dry weight of the coating composition.

21. Sublimation transfer paper according to claim 13, wherein the sublimation transfer paper has a Hagerty Porosity of about 10 sec/100 ml air to about 1000 sec/100 ml air.

22. Sublimation transfer paper according to claim 13, wherein the sublimation transfer paper has a Hagerty Porosity of about 50 sec/100 ml air to about 400 sec/100 ml air.

23. A method of sublimation printing on a substrate, the method comprising:
(a) reverse printing an image on a sublimable ink receptive coating composition on sublimation transfer paper using a sublimable ink, the sublimable ink receptive coating comprising:
(i) at least about 35 wt. % silica based on the dry weight of the coating composition; and
(ii) at least about 5 wt. % binder based on the dry weight of the coating composition;
(b) combining the sublimation transfer paper and a printing substrate; and
(c) transferring the reverse printed image from the sublimation transfer paper to the printing substrate to provide the printing substrate having the image applied thereto.

24. A method according to claim 23, wherein the substrate comprises textile.

25. A method according to claim 23, wherein the textile comprises an article of clothing.

26. A method according to claim 23, wherein the textile comprises a banner or sign.

27. A method according to claim 23, wherein the substrate comprises an article having a surface for receipt of the image, wherein the surface comprises metal, glass, ceramic, or plastic.

28. A method according to claim 23, wherein the coating composition comprises about 40 wt. % to about 80 wt. % silica based on the dry weight of the coating composition.

29. A method according to claim 23, wherein the coating composition comprises about 5 wt. % to about 40 wt. % binder based on the dry weight of the coating composition.

30. A method according to claim 23, wherein the coating composition further comprises clay, calcium carbonate, or a mixture of clay and calcium carbonate.

31. A method according to claim 23, further comprising a sizing composition on the other of the first side or the second side of the base sheet.

32. A method according to claim 23, wherein the sizing composition comprises a non-sublimable dye.

33. A method according to claim 23, wherein the paper substrate has a basis weight of about 20 lb/3,000 ft² to about 200 lb/3,000 ft².

34. A method according to claim 23, wherein the sublimable ink receptive coating is provided at a coat weight of about 3 lb./3000 ft² to about 5 lb./3000 ft² based on the dry weight of the coating composition.

35. A method according to claim 23, wherein sublimation transfer paper according to claim 1, wherein the paper substrate comprises paper formed from fiber having a level of refining of about 100 CSF to about 800 CSF.

36. A method according to claim 23, wherein sublimation transfer paper according to claim 1, wherein the paper substrate comprises paper formed from fiber having a level of refining of about 300 CSF to about 500 CSF.

37. A method according to claim 23, sublimation transfer paper according to claim 13, wherein the sublimation transfer paper has a Hagerty Porosity of about 10 sec/100 ml air to about 1000 sec/100 ml air.

38. A method according to claim 23, sublimation transfer paper according to claim 13, wherein the sublimation transfer paper has a Hagerty Porosity of about 50 sec/100 ml air to about 400 sec/100 ml air.

39. A method for making sublimation transfer paper, the method comprising:
(a) manufacturing a paper substrate from a pulp mixture, wherein the paper substrate has a first side and a second side;
(b) applying an aqueous sublimable ink receptive coating composition on at least one of the first side or the second side of the paper substrate, wherein the aqueous sublimable ink receptive coating composition has a solids content of about 5 wt. % to about 70 wt. % and comprises:
(i) at least about 35 wt. % silica based on the dry weight of the coating composition; and
(ii) at least about 5 wt. % binder based on the dry weight of the coating composition.

40. A method according to claim 27, wherein the steps of manufacturing a paper substrate and applying the aqueous sublimable ink receptive coating composition to at least one of the first side and the second side of the paper substrate are steps that occur during a continuous paper making process.
